(19) United States
(12) Patent Application Publication
(10) Pub. No.: US 2004/0019496 A1
(43) Pub. Date: Jan. 29, 2004

(54) System and method for law practice information management

(75) Inventors: Ava Angle, Houston, TX (US); Cheryl D. Murillo, Humble, TX (US); Marviette Usher, Houston, TX (US)

Correspondence Address: CHEVRON TEXACO CORPORATION, P.O. BOX 6006, SAN RAMON, CA, 94583-0806, US

(73) Assignee: Chevron U.S.A. Inc.

(21) Appl. No.: 10/406,867

(22) Filed: Apr. 4, 2003

Related U.S. Application Data
(60) Provisional application No. 60/384,739, filed on May 30, 2002.

(51) Int. Cl. G06F 17/60

(52) U.S. Cl. 705/1

(57) ABSTRACT

A system for law practice information management including: a database adapted and configured for storing docket records, party records, property records, document records, calendar records, settlement records, and/or financial records; a database management system for adding, deleting, updating, and searching records in the database; a server-class general purpose computer for hosting the database and the database management system; a network in communication with the server-class general purpose computer, for transmitting requests from a client program running on a host computer on or in communication with the network to the server-class general purpose computer, and returning responses from the server-class general purpose computer to the client program; and where at least some of the system is configured and adapted for data transmissions over the network to or from a web browser client.

### I. FIELD OF THE INVENTION

This invention relates to system and method for law practice information management, especially for tracking information associated with corporate claims, advice, regulatory and litigation matters.

### II. BACKGROUND OF THE INVENTION

Over the last few years the United States has seen an increase in class action and multiple-party litigation. This litigation has major financial exposure, and requires corporations to gather and manage tremendous volumes of detailed information. Corporations have continued to downsize their in-house attorneys resulting in fewer attorneys managing larger numbers of legal matters. The manual method of document and data management is no longer feasible because corporations must respond quicker and handle the information efficiently. Much of this data needs to be reused and reanalyzed in subsequent lawsuits.

Existing vendors of software products aimed at the legal market have attempted to solve this problem by developing independent packages to address only partially some of the specific problems. Individual packages attempting to address those problems, however, must be purchased separately and integrated together to attempt to solve all the information management issues. A system made by combining multiple applications does not provide adequate continuity. The data and system integration are archived at the end of each legal matter and the process starts again for the next legal matter.

Thus, there is a need for a comprehensive computer system for improving the process of tracking the varied information concerning people, events, properties and documents gathered and produced over the entire lifecycle of a corporate legal matter. The instant invention provides such a solution.

### III. SUMMARY OF THE INVENTION

It is an object of this invention: (i) to reduce the time to search, retrieve, sort, and organize data needed in legal practices to minutes rather than months; (ii) to have any information requested be returned in a more complete form than results from known methods and systems; (iii) to eliminate duplicative information, thereby reducing or eliminating data update or delete errors; and (iv) to permit data returned from a search request to be instantly available for analysis and reuse on other related legal matters.

It is further an object of this invention to provide a solution featuring a series of fully integrated components that allow for management of all aspects of a corporate legal matter throughout its entire lifecycle including but not limited to the following components: Docket Management System, including, Plaintiff/Participant Database, Property Database, Event/Calendar Database, Settlement Database, Financial Reporting Database, Document Management/Production System and mixtures thereof.

It is further an object of this invention to allow corporate legal departments to standardize data creation, preservation, analysis and reporting of information used in handling legal claims and matters. The invention is unique, for example, in that corporate knowledge management is maintained after the end of each legal matter. By using this invention and the data processed therein in many different ways and in multiple legal matters, redundant, inconsistent or incomplete results are minimized.

Accordingly, the invention in one embodiment is a system for law practice information management including a computer storage medium adapted and configured for storing at least one data structure for storing records selected from the group consisting of docket records, party records, property records, document records, calendar records, settlement records, financial records, and mixtures thereof; a software code portion configured and adapted for adding, deleting, updating, and searching the data structure in the computer storage medium; a general purpose computer for performing server functions operatively connected to the computer storage medium and the software code portion; a network in communication with the general purpose computer, adapted and configured for transmitting add, delete, query, or update requests of the data structure from a client program running on a host computer, operatively connected to the network, to the general purpose computer, and returning responses to the requests from the general purpose computer to the client program; and wherein at least a portion of the system is configured and adapted for data transmissions over the network to or from a web browser client.

In another embodiment of the invention, it includes a system for law practice information management including: a database adapted and configured for storing records selected from the group consisting of docket records, party records, property records, document records, calendar records, settlement records, financial records, and mixtures thereof; a database management system for adding, deleting, updating, and searching records in the database; a server-class general purpose computer for hosting the database and the database management system; a network in communication with the server-class general purpose computer, adapted and configured for transmitting requests from a client program running on a host computer on or in communication with the network to the server-class general purpose computer, and returning responses from the server-class general purpose computer to the client program; and where at least a portion of the system is configured and adapted for data transmissions over the network to or from a web browser client.

In another embodiment of the invention, it includes a system for law practice information management including: at least one web-accessible database adapted and configured for storing records selected from the group consisting of docket records, party records, property records, document records, calendar records, settlement records, financial records, and mixtures thereof; a web-enabled database management system for adding, deleting, updating, and searching records in the web-accessible database; a server-class general purpose computer for hosting the web-accessible database and the database management system; and a network in communication with the server-class general purpose computer, adapted and configured for transmitting requests using Internet protocols from a web client program running on a host computer on or in communication with the network to the server-class general purpose computer, and returning responses using Internet protocols from the server-class general purpose computer to the web client program.

In another embodiment of the invention, it includes a method for law practice information management including: entering into a single database all case information comprising parties, counsel, properties and subject matter; distributing documents in the database over a network to counsel, experts, or advisors; entering into the database all discovery requests, discovery responses, and produced documents; accessing the database in preparing for court hearings, meetings or trials by scheduling events, assigning activities and tasks; accessing the database during trials to present evidence or impeach witnesses; accessing the database to summarize and analyze cost information; entering into the database any settlement offers, counter-offers, and agreements; entering into a client interface search form standard or custom search queries to the database; and wherein at least a portion of the method steps utilize a web browser client.

In another embodiment of the invention, it includes a method for law practice information management including: entering into a single web-enabled database all case information comprising parties, counsel, properties and subject matter; distributing documents in the database over the Internet to counsel, experts, or advisors; entering into the database all discovery requests, discovery responses, and produced documents; accessing the database in preparing for court hearings, meetings or trials by scheduling events, assigning activities and tasks; accessing the database during trials to present evidence or impeach witnesses; accessing the database to summarize and analyze cost information; entering into the database any settlement offers, counter-offers, and agreements; entering into a web interface search form standard or custom search queries to the database.

In another embodiment of the invention, it includes a method for law practice information management including entering into a single web-enabled database all case information selected from the group consisting of parties, counsel, properties' subject matter, and mixtures thereof; distributing documents in the database over the Internet to entities selected from the group consisting of counsel, experts, advisors, and mixtures thereof; entering into the database discovery documents selected from the group consisting of discovery requests, discovery responses, produced documents, and mixtures thereof; accessing the database for the purpose selected from the group consisting of accessing the database for preparing for court hearings, meetings or trials by scheduling events, assigning activities and tasks; accessing the database for the purpose selected from the group consisting of accessing the database during trials to present evidence or impeach witnesses; accessing the database to summarize and analyze cost information; entering into the database any settlement offers, counter-offers, and agreements; and entering into a web interface search form standard or custom search queries to the database.

### IV. BRIEF DESCRIPTION OF THE DRAWINGS

FIG. 1 is a schematic block system diagram of one embodiment of the invention.

FIG. 2 is a schematic block entity-relationship diagram depicting, in one embodiment of the invention, the entities participating in the invention and their relationships.

FIG. 3 is a schematic block context diagram of one embodiment of the invention.

FIG. 4 depicts a Conceptual Data Model in one embodiment of the invention, simplified view of tables, attributes, and relationships for implementing the database aspects of the invention.

FIG. 5 is a schematic block use-case diagram of one embodiment of the invention.

FIG. 6 is a schematic process model, level 0 data flow diagram of one embodiment of the invention.

FIG. 7 is a schematic logical view of one embodiment of the user-access rights aspect of the invention.

### V. DETAILED DESCRIPTION OF PREFERRED EMBODIMENTS

A. Introduction

The following discussion and figures include a general description of a suitable computing environment in which the invention may be implemented. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The invention generally relates to a law practice information management system. Basic components of an information management system include: all of the software which will create, update, and manage the system, storage devices, processing devices, input/output devices, and network devices and software.

Referring now to the drawings, in which like numerals represent like elements throughout the several figures, aspects of the present invention and a suitable operating environment will be described.

B. System

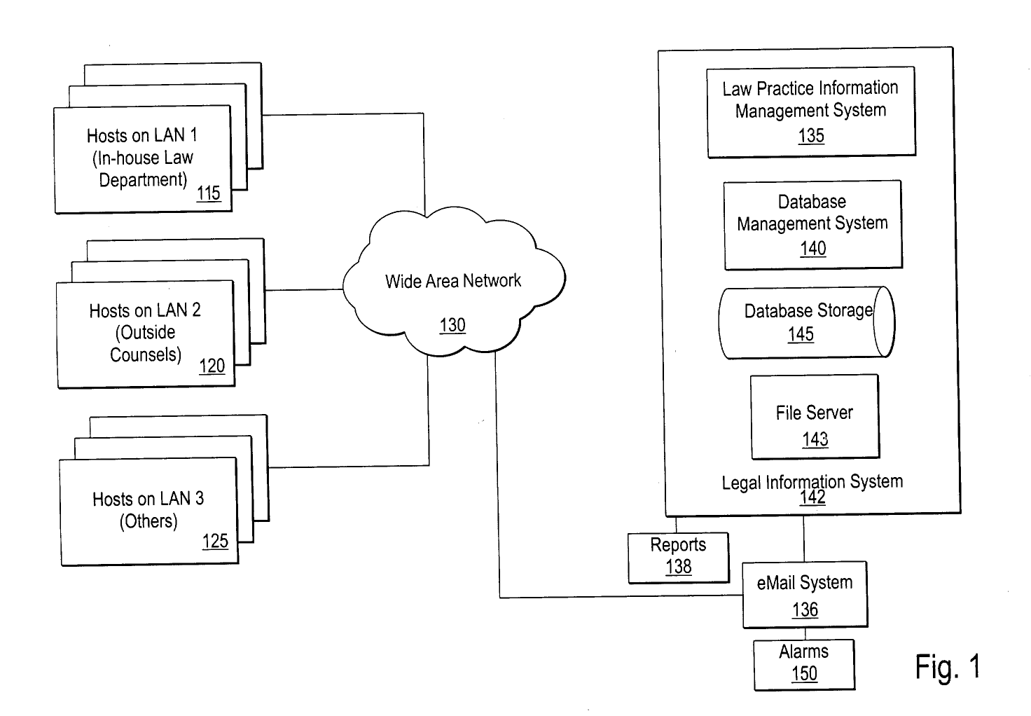

FIG.1 is a schematic block system diagram of one embodiment of the invention. Each entity involved in the method, in one embodiment, is depicted. The various components and participants using the system are interconnected via Wide Area Network 130. In-house counsel, outside counsel, and others are exemplary users of the system and are depicted as Hosts on LAN 1, block 115, Hosts on LAN 2, block 120, and hosts on LAN 3, block 125, respectively. Legal Information System 142 is connected to Wide Area Network 130, to eMail System 136, and to Reports 138. Legal Information System 142 includes law practice information management system 135, database management system 140, database storage 145, and file server 143. Reports 138 and alarms 150 via eMail system 136 issue from legal information system 142.

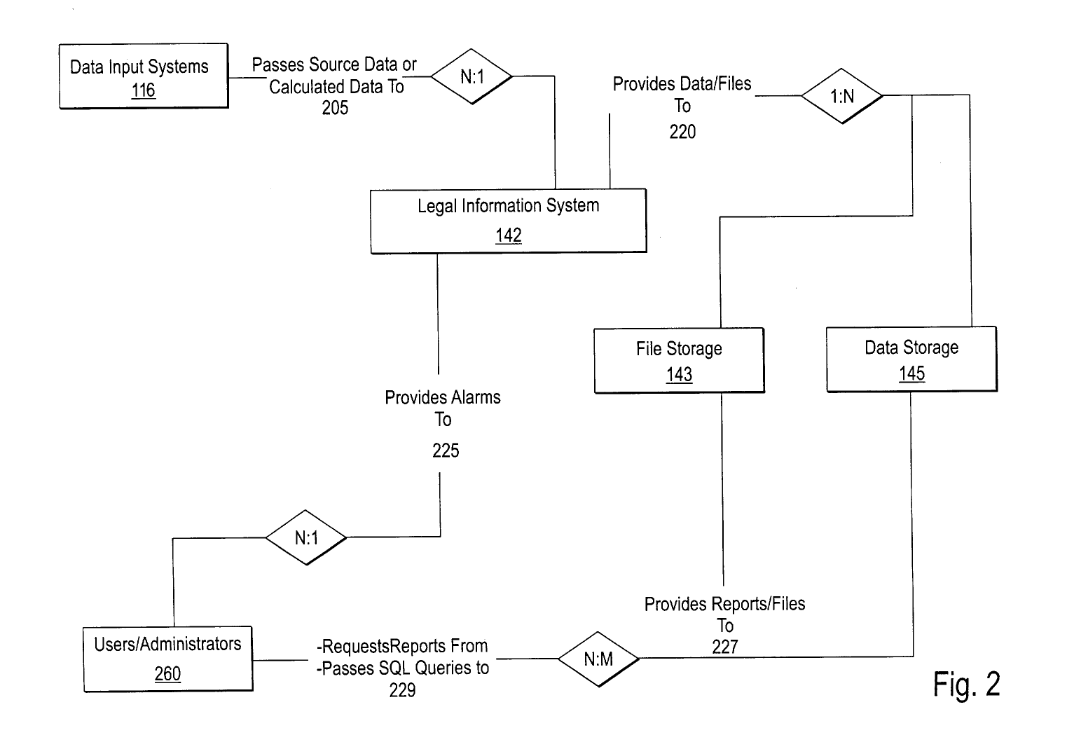

The relationships between these entities are provided in FIG. 2. Wide Area Network 130 is optionally the Internet or other public or private networks or combinations thereof. The communication of all entities through a common Wide Area Network 130 is illustrative only, and the invention includes embodiments where some entities communicate through one network, other entities through a different network, and various permutations thereof. That is, the Legal Information Management System 142, as well as any general-purpose computers utilized by users, e.g., Hosts 115, 120, and 125, and other entities (collectively, the “nodes”) preferably transmit digitally encoded data and other information between one another.

The communication links between the nodes preferably comprise a cable, fiber or wireless link on which electronic signals can propagate. For example, each node may be connected via an Internet connection using a public switched telephone network (PSTN), such as those provided by a local or regional telephone operating company. Alternatively, each node may be connected by dedicated data lines, cellular, Personal Communication Systems (“PCS”), microwave, or satellite networks.

FIG. 2 is a schematic diagram depicting a conceptual data model/entity-relationship diagram. It shows the key entities of one embodiment of the invention and their interrelationships and key messages transferring between the entities in the practice of the method and system of the invention. The diagram is described in the context of an example for one embodiment of a method/process according to the invention. Data 205, including documents, are input to the Legal Information System 142 via one or more Data Input Systems 116. Legal Information System 142 either stores data 205 as received processes according to business rules, therefore converting it to information 220 or stores data 205 and information 220 in data storage 145 and files in file storage 143.

Data storage 145 is any conventional hardware and/or software for storing data of the database in known architectures such as relational databases. File storage 143 is any conventional file storage hardware and software such as file server hardware and software. Both file storage 143 and data storage 145 are configured for providing reports and files 227 to one or more users/administrators 260. Such reports typically are in response to queries posed by users/administrators 260 but are not so limited. That is, business rules for automatic generation or delivery of reports or files may be included, e.g., regularly scheduled status reports. Legal Information System 142 optionally is configured to provide alarms 150 to the users/administrators 260. Alarms may be standard system alarms or based on customized rules created by users/administrators 260, e.g., notification of an imminent docket date deadline.

C. Method

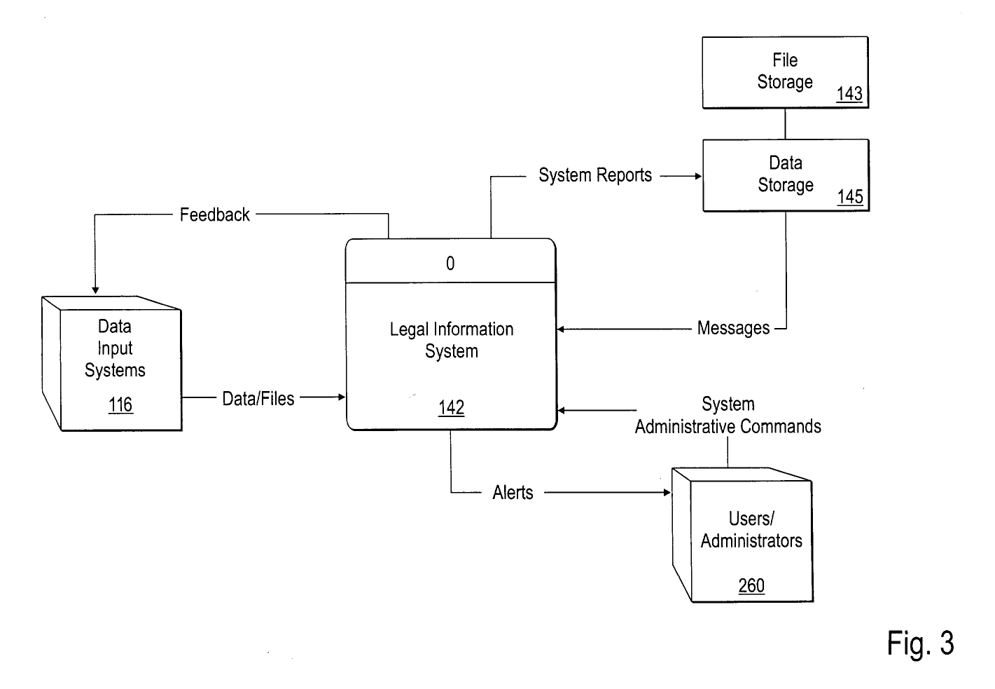

The method/process aspect of the invention is illustrated and described in FIGS. 3, 5 and 6 as a series of process steps. As would be clear to one skilled in the art, the process steps can be embodied as code for a computer program for operation on a conventional programmed digital computer, such as clients (users/administrators 260) and server (Legal Information System 142 and Data/File Storage 145/143). The program code can be embodied as a computer program on a computer-readable storage medium or as a computer data signal in a carrier wave transmitted over Wide Area Network 130 (shown in FIG. 1).

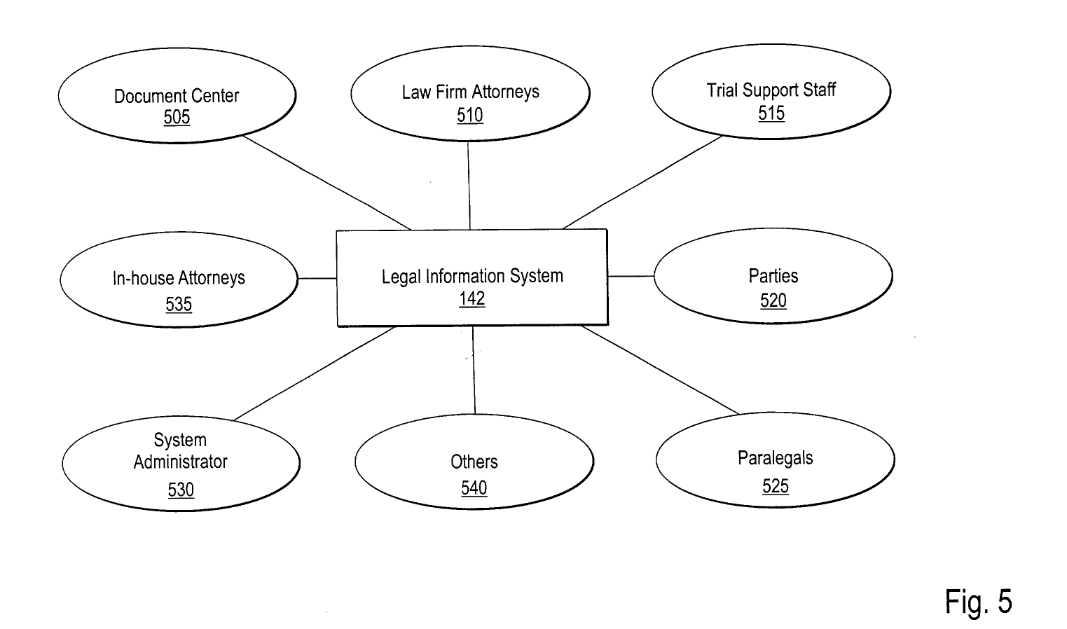

FIG. 3 is a schematic block context diagram of one embodiment of the invention. Entities interacting with Legal Information System 142 include Data Input Systems 116, Users/Administrators 260, and Data/File Storage 145/143. Other entities not shown are contemplated within the scope of the invention. Users/Administrators 260 includes attorneys, administrative and other legal staff, courts, party principles, consultants, witnesses, and other interested parties. FIG. 5 depicts in one embodiment exemplary users interacting with Legal Information System 142. These include, but are not limited to, Document Center 505, Law Firm Attorneys 510, Trial Support Staff 515, Parties 520, Paralegals 525, System Administrators 530, In-house Attorneys 535, and Others 540.

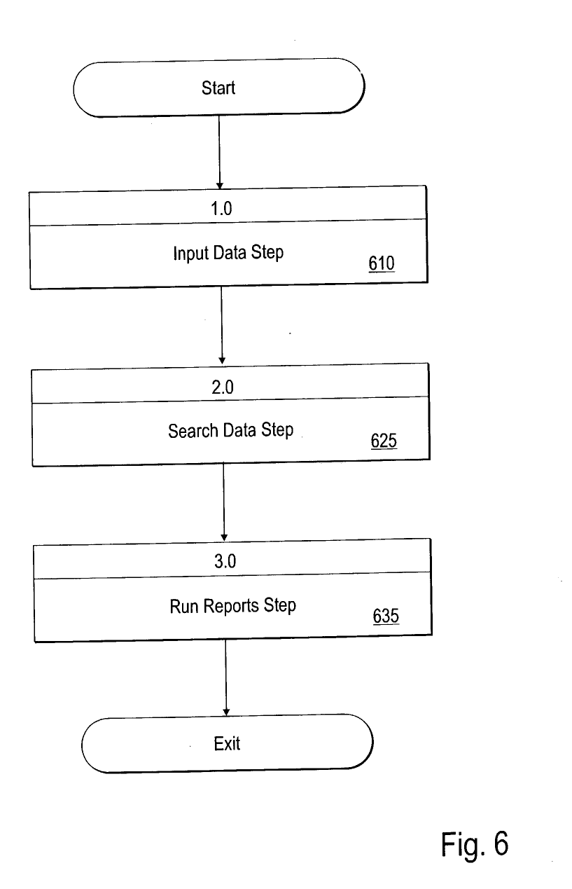

Referring again to FIG. 3, users/administrators 260 both pass and request data and files from Legal Information System 142 and receive data and files as well as optionally reports and alerts. Data Input Systems 116 may include some users/administrators 260, e.g., where data is keyed in, but also may include automated data entry systems such as optical scanners, data or files received over Wide Area Network 130, e.g., from a court, other governmental agency, or from automatically generated or collected data from other information systems. Legal Information Systems 142 stores data and files in data/file store 145/143. As shown in FIG. 6, there are in one embodiment three main steps of using the Legal Information System 142. First input data step 610, then search data step 625, and then run reports step 635. These are only exemplary steps and the invention contemplates other related steps including, but not limited to,:creating, deleting, and updating data, alarms, automated reports, and interactive user-access.

A user may log on using a typical personal computer system or workstation system. Conventional or other types of security and/or user-access rights management are typically included.

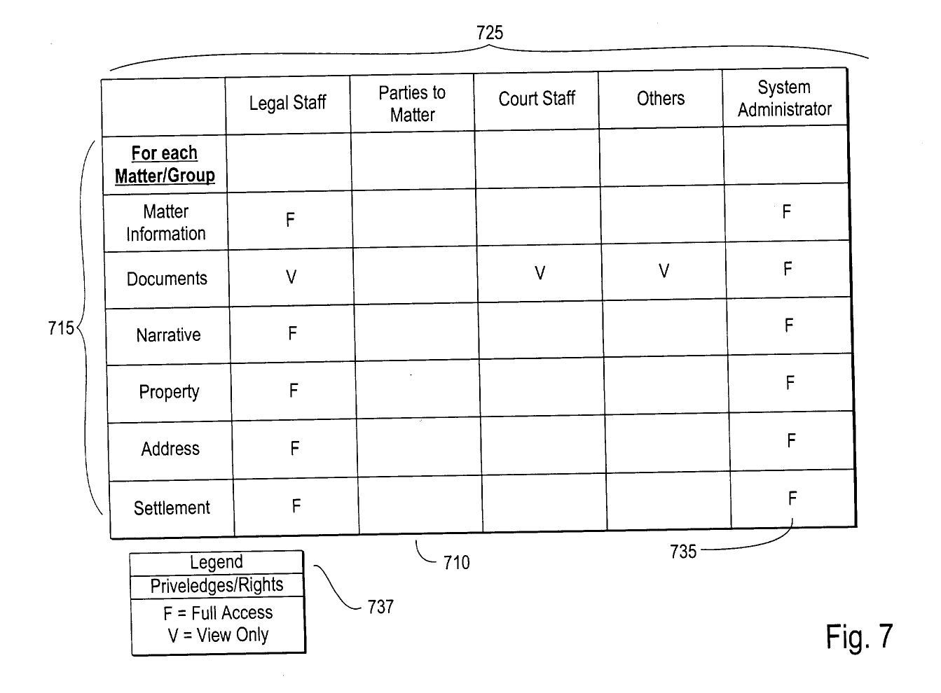

FIG. 7 is a schematic logical view of one embodiment of the user-access rights aspect of the invention. A table 710 is maintained defining user-access rights for categories 715 for all user groups 725. For example, system administrators have full access rights (as shown by “F” 735), but court staff have view only rights. Each user would be assigned a matter/group, an access category and have the rights associated with that category. A change in the master access-category table would thus propagate to all users having an assigned category. Many other systems are possible.

A typical personal computer or workstation a user might log on with would include typical components such as a bus for communicating information, and a processor coupled with the bus for processing information, random access memory, coupled to the bus for storing information and instructions to be executed by the processor. Random Access Memory also may be used for storing temporary variables or other intermediate information during execution of instructions by the processor, a read only memory coupled to the bus for storing static information and instructions for the processor, and a data storage device coupled to the bus for storing information and instructions. The data storage device may include a magnetic disk or optical disk and its corresponding disk drive can be coupled to the computer system. Also the system may be coupled via the bus to a display device, such as a cathode ray tube, for displaying information to a computer user. The computer system further includes a keyboard and a cursor control, such as a mouse. Any other access devices for accessing a network are intended to be included in the invention. Such devices may include properly equipped and configured cellular phones and personal digital assistants.

While the preferred network is the Internet, other networks may be used, preferably capable of transmitting using any Network Protocol. The communication links between the entities for implementing the network preferably comprises a cable, fiber or wireless link on which electronic signals can propagate. For example, each entity may be connected via an Internet connection using a public switched telephone network such as those provided by a local or regional telephone operating company. Alternatively, each entity may be connected by dedicated data lines, cellular, Personal Communication Systems, microwave, or satellite networks.

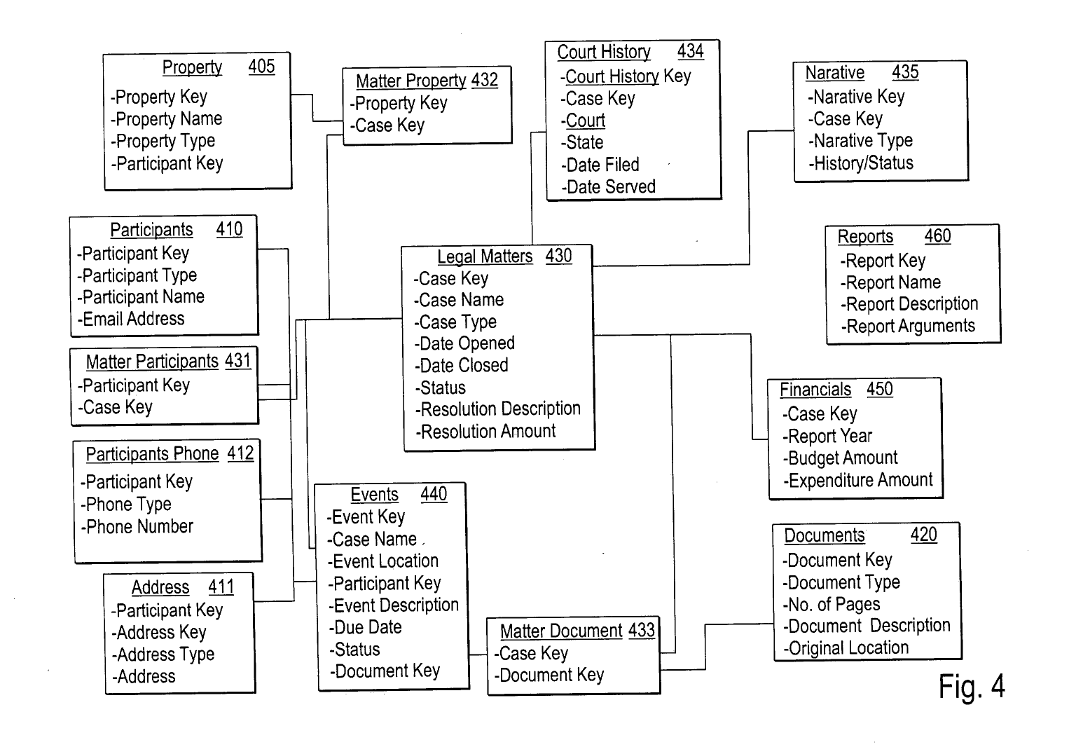

FIG. 4 depicts in one embodiment of the invention, a conceptual data model for implementing databases described herein. This simplified data model depicts exemplary key tables used in implementing the databases required for use of the invention. Participants Table 410 contains participant data such as key attribute participant key, participant name and participant type. Address Table 411 contains participant address data and Participant Phone Table 412 contains participant contact data. Properties Table 405 contains data about any property relevant to the legal dispute or other legal matter in question. It contains data such as key attribute property key, property name, property type and owner participant key.

Legal matter table 430 is the central table where the law management information system is used in legal dispute information management. It includes key attribute legal matter key, date opened, date closed, status, resolution description and resolution amount. Court Table 434 contains legal matter data such as court name, docket number, date served and date filed. Narrative Table 435 contains additional legal matter data such as legal matter history. Legal matter key links to many other tables, Matter Participants 431, Matter Properties 432, and Matter Documents 433.

Other tables include Documents Table 420, Financial Table 450, Docket Events Table 440, and Reports Table 460. Each contains a key attribute and is linked to one or more other table via this key attribute and/or via containing a foreign key of another table. FIG. 4 is only one exemplary data model. Modification of the shown tables as well as additional tables, their domains, keys, and links to other tables, and associated queries and reports, and appropriate normalization of each, useful in implementing the databases used in the invention, given the disclosure herein, could be implemented by data base designers of ordinary skill in the art.

D. Other Implementation Details

1. Terms

The detailed description contained herein is represented partly in terms of processes and symbolic representations of operations by a conventional computer. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is a type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

2. Hardware

It should be understood that the programs, processes, methods, etc. described herein are not related or limited to any particular computer or apparatus, nor are they related or limited to any particular communication architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

3. Program

In the preferred embodiment, the steps of the present invention are embodied in machine-executable instructions. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

4. Product

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

5. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

6. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

7. Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

What is claimed is:

1. A system for law practice information management comprising:
(a) a computer storage medium adapted and configured for storing at least one data structure for storing records selected from the group consisting of docket records, party records, property records, document records, calendar records, settlement records, financial records, and mixtures thereof;
(b) a software code portion configured and adapted for adding, deleting, updating, and searching the data structure in the computer storage medium;
(c) a general purpose computer for performing server functions operatively connected to the computer storage medium and the software code portion;
(d) a network in communication with the general purpose computer, adapted and configured for transmitting add, delete, query, or update requests of the data structure from a client program running on a host computer, operatively connected to the network, to the general purpose computer, and returning responses to the requests from the general purpose computer to the client program; and
(e) wherein at least a portion of the system is configured and adapted for data transmissions over the network to or from a web browser client.

2. The System of claim 1, wherein the general purpose computer is further adapted and configured for transmitting requests using Internet protocols from a web client program.

3. The System of claim 1, wherein the network comprises the Internet.

4. The System of claim 1, wherein the at least one data structure is stored in a relational database.

5. A system for law practice information management comprising:
(a) a database adapted and configured for storing records selected from the group consisting of docket records, party records, property records, document records, calendar records, settlement records, financial records, and mixtures thereof;
(b) a database management system for adding, deleting, updating, and searching records in the database;
(c) a server-class general purpose computer for hosting the database and the database management system;
(d) a network in communication with the server-class general purpose computer, adapted and configured for transmitting requests from a client program running on a host computer on or in communication with the network to the server-class general purpose computer, and returning responses from the server-class general purpose computer to the client program; and
(e) wherein at least a portion of the system is configured and adapted for data transmissions over the network to or from a web browser client.

6. The System of claim 5, wherein the server-class general purpose computer is further adapted and configured for transmitting requests using Internet protocols from a web client program running on a host computer on or in communication with the network to the server-class general purpose computer.

7. The System of claim 5, wherein the network comprises the Internet.

8. The System of claim 5, wherein the database is a relational database.

9. A system for law practice information management comprising:
(a) at least one web-accessible database adapted and configured for storing records selected from the group consisting of docket records, party records, property records, document records, calendar records, settlement records, financial records, and mixtures thereof;
(b) a web-enabled database management system for adding, deleting, updating, and searching records in the web-accessible database;
(c) a server-class general purpose computer for hosting the web-accessible database and the database management system; and
(d) a network in communication with the server-class general purpose computer, adapted and configured for transmitting requests using Internet protocols from a web client program running on a host computer on or in communication with the network to the server-class general purpose computer, and returning responses using Internet protocols from the server-class general purpose computer to the web client program.

10. The System of claim 9, wherein the server-class general purpose computer is further adapted and configured for transmitting requests using Internet protocols from a web client program running on a host computer on or in communication with the network to the server-class general purpose computer.

11. The System of claim 9, wherein the network comprises the Internet.

12. The System of claim 9, wherein the database management system is configured and adapted for managing a relational database.

13. A method for law practice information management comprising:
(a) entering into a single database all case information comprising parties, counsel, properties and subject matter;
(b) distributing documents in the database over a network to counsel, experts, or advisors;
(c) entering into the database all discovery requests, discovery responses, and produced documents;
(d) accessing the database in preparing for court hearings, meetings or trials by scheduling events, assigning activities and tasks;
(e) accessing the database during trials to present evidence or impeach witnesses;
(f) accessing the database to summarize and analyze cost information;
(g) entering into the database any settlement offers, counter-offers, and agreements;
(h) entering into a client interface search form standard or custom search queries to the database; and
(i) wherein at least a portion of the method steps utilize a web browser client.

14. The System of claim 13, wherein the network comprises the Internet.

15. The System of claim 13, wherein the database is a relational database.

16. A method for law practice information management comprising:
(a) entering into a single web-enabled database all case information comprising parties, counsel, properties and subject matter;
(b) distributing documents in the database over the Internet to counsel, experts, or advisors;
(c) entering into the database all discovery requests, discovery responses, and produced documents;
(d) accessing the database in preparing for court hearings, meetings or trials by scheduling events, assigning activities and tasks;
(e) accessing the database during trials to present evidence or impeach witnesses;
(f) accessing the database to summarize and analyze cost information;
(g) entering into the database any settlement offers, counter-offers, and agreements;
(h) entering into a web interface search form standard or custom search queries to the database.

17. The System of claim 16, wherein the database is a relational database.

18. A method for law practice information management comprising:
(a) entering into a single web-enabled database all case information selected from the group consisting of parties, counsel, properties, subject matter, and mixtures thereof;
(b) distributing documents in the database over the Internet to entities selected from the group consisting of counsel, experts, advisors, and mixtures thereof;
(c) entering into the database discovery documents selected from the group consisting of discovery requests, discovery responses, produced documents, and mixtures thereof;
(d) accessing the database for the purpose selected from the group consisting of accessing the database for preparing for court hearings, meetings or trials by scheduling events, assigning activities and tasks;
(e) accessing the database for the purpose selected from the group consisting of accessing the database during trials to present evidence or impeach witnesses;
(f) accessing the database to summarize and analyze cost information;
(g) entering into the database any settlement offers, counter-offers, and agreements; and
(h) entering into a web interface search form standard or custom search queries to the database.

19. The System of claim 18, wherein the database is a relational database.
